(19) United States
(12) Patent Application Publication
(10) Pub. No.: US 2023/0145144 A1
(43) Pub. Date: May 11, 2023

(54) COMPOSITION, WET WIPER, SPRAY, MASK WITH ANTIBACTERIAL AGENT, FACE GUARD WITH ANTIBACTERIAL AGENT, AND ANTIBACTERIAL LIQUID MATERIAL

(71) Applicant: FUJIFILM Corporation, Tokyo (JP)

(72) Inventors: Shinsuke MOROMIZATO, Shizuoka (JP); Masayuki KURAMITSU, Shizuoka (JP)

(73) Assignee: FUJIFILM Corporation, Tokyo (JP)

(21) Appl. No.: 18/147,711

(22) Filed: Dec. 29, 2022

Related U.S. Application Data
(63) Continuation of application No. PCT/JP2021/024980, filed on Jul. 1, 2021.

(30) Foreign Application Priority Data
Jul. 6, 2020 (JP) 2020-116619
Feb. 9, 2021 (JP) 2021-019195
Jun. 25, 2021 (JP) 2021-106040

(51) Int. Cl. A01N 59/16; A01N 25/02; A01N 25/34; A01P 1/00

(52) U.S. Cl. CPC A01N 59/16; A01N 25/02; A01N 25/34; A01P 1/00

(57) ABSTRACT

The present invention provides a composition containing an antibacterial agent, which suppresses occurrence of rust even in a case of being applied to a metal base material such as SUS; a wet wiper; a spray; a mask with an antibacterial agent; a face guard with an antibacterial agent; and an antibacterial liquid material. The composition of the present invention contains a hydrophilic component selected from the group consisting of a hydrophilic binder precursor and a hydrophilic binder, an antibacterial agent, and a solvent, in which a first antibacterial activity value obtained by a predetermined test 1 is 4.0 or less, and a second antibacterial activity value obtained by a predetermined test 2 is 4.0 or more.

### CROSS-REFERENCE TO RELATED APPLICATIONS

This application is a Continuation of PCT International Application No. PCT/JP2021/024980 filed on Jul. 1, 2021, which claims priority under 35 U.S.C. § 119(a) to Japanese Patent Application No. 2020-116619 filed on Jul. 6, 2020, Japanese Patent Application No. 2021-019195 filed on Feb. 9, 2021 and Japanese Patent Application No. 2021-106040 filed on Jun. 25, 2021. The above applications are hereby expressly incorporated by reference, in its entirety, into the present application.

### BACKGROUND OF THE INVENTION

### 1. Field of the Invention

The present invention relates to a composition, a wet wiper, a spray, a mask with an antibacterial agent, a face guard with an antibacterial agent, and an antibacterial liquid material.

### 2. Description of the Related Art

As a technology to prevent contamination by bacteria and the like, attention has been paid to a technology for imparting an antibacterial action.

JP4830075B discloses an antiviral agent composition containing a silicon-containing compound.

### SUMMARY OF THE INVENTION

A composition containing a material having an antibacterial action (hereinafter, also referred to as an antibacterial composition) has been applied to various uses, and the composition may be applied to metal base materials such as stain less steel (SUS).

In a case where the antibacterial composition in the related art is applied to a metal base material, rust may occur on the metal base material. In particular, the antibacterial composition is often applied to the metal base material a plurality of times, and in such a case, the rust may easily occur.

An object of the present invention is to provide a composition containing an antibacterial agent, which suppresses occurrence of rust even in a case of being applied to a metal base material such as SUS.

Another object of the present invention is to provide a wet wiper, a spray, a mask with an antibacterial agent, a face guard with an antibacterial agent, and an antibacterial liquid material.

As a result of conducting an extensive investigation to achieve the objects, the present inventors have found that the objects can be achieved by the following constitution.

(1) A composition comprising:
a hydrophilic component selected from the group consisting of a hydrophilic binder precursor and a hydrophilic binder;
an antibacterial agent; and
a solvent,
in which a first antibacterial activity value obtained by a test 1 described later is 4.0 or less, and
a second antibacterial activity value obtained by a test 2 described later is 4.0 or more.

The composition according to (1),

in which a content of the hydrophilic component is 0.20% to 0.31% by mass with respect to a total mass of the composition.

The composition according to (1) or (2),

in which a content of the antibacterial agent is 0.005% to 0.060% by mass with respect to a total mass of the composition.

The composition according to any one of (1) to (3),

in which a content of the antibacterial agent is 0.013% to 0.022% by mass with respect to a total mass of the composition.

The composition according to any one of (1) to (4),

in which the antibacterial agent contains silver.

The composition according to any one of (1) to (5),

in which the hydrophilic component is a silicate-based compound.

The composition according to (6), further comprising:

a catalyst which promotes a condensation of the silicate-based compound.

The composition according to (7),

in which a content of the catalyst is 0.011% to 0.019% by mass with respect to a total mass of the composition.

The composition according to any one of (1) to (8),
in which the solvent contains an alcohol-based solvent, and
a content of the alcohol-based solvent is 82.0% by mass or less with respect to a total mass of the composition.

The composition according to any one of (1) to (9),

in which the composition is a gel agent.

A wet wiper comprising:
a foundation cloth; and
the composition according to any one of (1) to (10), which is impregnated into the foundation cloth.

A spray comprising:
a spray container; and
the composition according to any one of (1) to (10), which is stored in the spray container.

A mask with an antibacterial agent, comprising:
a mask; and
an antibacterial portion which is disposed on the mask and includes an antibacterial agent formed from the composition according to any one of (1) to (10).

A face guard with an antibacterial agent, comprising:
a face guard; and
an antibacterial portion which is disposed on the face guard and includes an antibacterial agent formed from the composition according to any one of (1) to (10).

An antibacterial liquid material comprising:

the composition according to any one of (1) to (9).

According to the present invention, it is possible to provide a composition containing an antibacterial agent, which suppresses occurrence of rust even in a case of being applied to a metal base material such as SUS.

According to the present invention, it is possible to provide a wet wiper, a spray, a mask with an antibacterial agent, a face guard with an antibacterial agent, and an antibacterial liquid material.

### DESCRIPTION OF THE PREFERRED EMBODIMENTS

Hereinafter, the present invention will be described in detail.

In a case where substitution or unsubstitution is not noted in regard to the notation of a “group” (atomic group) in the present specification, the “group” includes not only a group not having a substituent but also a group having a substituent within a range that does not impair the effects of the present invention. For example, “alkyl group” denotes not only an alkyl group having no substituent (unsubstituted alkyl group) but also an alkyl group having a substituent (substituted alkyl group). This also applies to each compound.

In addition, in the present specification, “(meth)acrylate” represents acrylate and/or methacrylate (either or both of acrylate and methacrylate), and “(meth)acryloyl” represents acryloyl and/or methacryloyl (either or both of acryloyl and methacryloyl).

In addition, in the present specification, the numerical ranges shown using “to” indicate ranges including the numerical values described before and after “to” as the lower limit value and the upper limit value.

A feature point of the composition according to the embodiment of the present invention (hereinafter, also simply referred to as a “present composition”) is that the composition exhibits a predetermined antibacterial activity value.

In a study on a reason why rust occurs in a case where the composition containing an antibacterial agent in the related art is applied to a metal base material such as SUS, the present inventors have found that so-called crevice corrosion occurs. Surprisingly, the present inventors have found that, in a case of using a composition exhibiting a predetermined antibacterial activity value, the occurrence of the rust (occurrence of the crevice corrosion) is suppressed. Details of the reason why the composition exhibiting a predetermined antibacterial activity value exerts the above-described effect of the present invention are not clear, but are presumed as follows. First, the antibacterial activity value is related to an elution amount of an antibacterial agent component, and this elution amount is also related to an adhesiveness of an antibacterial portion to the metal base material. It is presumed that, by using the composition exhibiting a predetermined antibacterial activity value, an antibacterial portion that exhibits an adhesiveness such that the crevice corrosion is unlikely to occur is formed.

In the present composition, a first antibacterial activity value obtained the following test 1 is 4.0 or less, and a second antibacterial activity value obtained by the following test 2 is 4.0 or more.

Test 1: in a case where Escherichia coli is inoculated on a polyethylene terephthalate film (PET film) and a common logarithmic value of the number of viable bacteria on the PET film after culturing the Escherichia coli for 3 hours under conditions of 35 ± 1° C. and a relative humidity of 90% RH or more is defined as a common logarithmic value X1, and in a case where 9.6 g/m² of the present composition is applied onto a PET film using a nonwoven fabric impregnated with the present composition and a drying operation is repeated five times to produce a PET film coated with the present composition, Escherichia coli is inoculated on the PET film coated with the present composition, and a common logarithmic value of the number of viable bacteria on the PET film coated with the present composition after culturing the Escherichia coli for 3 hours under conditions of 35 ± 1° C. and a relative humidity of 90% RH or more is defined as a common logarithmic value Y1, a difference between the common logarithmic value X1 and the common logarithmic value Y1 is calculated as the first antibacterial activity value.

Test 2: in a case where Escherichia coli is inoculated on a PET film and a common logarithmic value of the number of viable bacteria on the PET film after culturing the Escherichia coli for 24 hours under conditions of 35 ± 1° C. and a relative humidity of 90% RH or more is defined as a common logarithmic value X2, and in a case where 9.6 g/m² of the present composition is applied onto a PET film using a nonwoven fabric impregnated with the present composition and a drying operation is repeated five times to produce a PET film coated with the present composition, Escherichia coli is inoculated on the PET film coated with the present composition, and a common logarithmic value of the number of viable bacteria on the PET film coated with the present composition after culturing the Escherichia coli for 24 hours under conditions of 35 ± 1° C. and a relative humidity of 90% RH or more is defined as a common logarithmic value Y2, a difference between the common logarithmic value X2 and the common logarithmic value Y2 is calculated as the second antibacterial activity value.

Hereinafter, the tests 1 and 2 will be described in detail.

In the tests 1 and 2, a PET film is used. As the PET film, a PET film having a length of 5 cm and a width of 5 cm is used.

Bacterium used in the tests 1 and 2 is Escherichia coli.

In the test 1, the common logarithmic value X1 and the common logarithmic value Y1 are calculated, and the difference therebetween is calculated.

As a method for calculating the common logarithmic value X1, first, Escherichia coli is inoculated on the PET film and cultured for 3 hours under the conditions of 35 ± 1° C. and a relative humidity of 90% RH or more. Examples of a method of inoculating the PET film with the Escherichia coli include a method of dropping a solution including the Escherichia coli onto the PET film. A film may be disposed on a surface of the PET film inoculated with the Escherichia coli. Examples of the film to be disposed include a PET film.

Next, the PET film inoculated with the Escherichia coli is cultured for 3 hours under the conditions of 35 ± 1° C. and a relative humidity of 90% RH or more. In a case of culturing the Escherichia coli, for example, the above-described PET film inoculated with the Escherichia coli may be placed in a Petri dish and a culture treatment may be carried out.

After completion of the culture, the Escherichia coli on the PET film is washed out with a culture medium (for example, 10 mL of SCDLP culture medium), and the washed-out solution is recovered. Next, the number of viable bacteria in the recovered liquid is measured by an agar plate culture method, and a common logarithmic value of the obtained number of viable bacteria is defined as the common logarithmic value X1.

As a method for calculating the common logarithmic value Y1, first, 9.6 g/m² of the present composition is applied onto a PET film using a nonwoven fabric impregnated with the present composition, and then a drying operation is repeated five times to produce a PET film coated with the present composition.

As the nonwoven fabric used, a nonwoven fabric (rayon:PET:polyethylene (PE) = 5:3:2, areal weight amount: 4 g/m²) is used. In addition, examples of a method of impregnating the nonwoven fabric with the present composition include a method of impregnating the nonwoven fabric with the present composition (10 mL) for 24 hours.

Examples of a method of applying the present composition onto the PET film using the nonwoven fabric impregnated with the present composition include a method of applying the present composition onto the PET film by wiping the PET film with the nonwoven fabric. In a case of the coating, an applying amount of the present composition onto the PET film is adjusted to be 9.6 g/m².

The present composition is dried after being applied onto the PET film. As a drying method, it is preferable to perform natural drying at room temperature (23° C.).

Next, the PET film coated with the present composition is produced, Escherichia coli is inoculated on the PET film coated with the present composition (on a surface of the PET film, coated with the present composition), and a common logarithmic value of the number of viable bacteria on the PET film coated with the present composition after culturing the Escherichia coli for 3 hours under the conditions of 35 ± 1° C. and a relative humidity of 90% RH or more is defined as the common logarithmic value Y1.

The above-described method of inoculating and culturing the Escherichia coli is the same as the above-described inoculation method and culturing method performed in obtaining the common logarithmic value X1. The method of calculating the number of viable bacteria on the PET film after the completion of the culture is also the same as the above-described method performed in obtaining the common logarithmic value X1.

By performing the above-described procedure, the common logarithmic value Y1 is obtained.

Next, the difference between the common logarithmic value X1 and the common logarithmic value Y1 obtained above is calculated as the first antibacterial activity value.

In the test 2, the common logarithmic value X2 and the common logarithmic value Y2 are calculated, and the difference therebetween is calculated.

The common logarithmic value X2 is calculated by the same method as the above-described method for calculating the common logarithmic value X1, except that the culture time is changed from 3 hours to 24 hours.

The common logarithmic value Y2 is calculated by the same method as the above-described method for calculating the common logarithmic value Y1, except that the culture time is changed from 3 hours to 24 hours.

Next, the difference between the common logarithmic value X2 and the common logarithmic value Y2 obtained above is calculated as the second antibacterial activity value.

The first antibacterial activity value is 4.0 or less. Among these, from the viewpoint that the effect of the present invention is more excellent, 3.8 or less is preferable. The lower limit thereof is not particularly limited, but is preferably 2.0 or more and more preferably 3.0 or more.

In addition, the second antibacterial activity value is 4.0 or more. Among these, from the viewpoint that the effect of the present invention is more excellent, 5.0 or more is preferable. The upper limit thereof is not particularly limited, but may be 6.0 or less.

The composition according to the embodiment of the present invention contains a hydrophilic component selected from the group consisting of a hydrophilic binder precursor and a hydrophilic binder, an antibacterial agent, and a solvent.

Hereinafter, various components contained in the present composition will be described in detail.

### Hydrophilic Binder or Precursor Thereof

The present composition contains a hydrophilic component selected from the group consisting of a hydrophilic binder precursor and a hydrophilic binder.

The hydrophilic binder precursor is intended to be a material capable of forming a hydrophilic binder by a curing reaction such as condensation and polymerization.

In addition, the hydrophilic binder is intended to be a material capable of forming a hydrophilic film which can support the antibacterial agent or the like. As the hydrophilic binder, in a case where a film made of the above-described hydrophilic binder is formed on a glass substrate, for example, a water contact angle of the film is preferably 60° or less, and more preferably 50° or less. The lower limit of the water contact angle of the film is not particularly limited, but is generally 5° or more.

The water contact angle is measured based on a sessile drop method of JIS R 3257:1999. For the measurement, FAMMS DM-701 manufactured by Kyowa Interface Science Co., Ltd. is used.

Specific examples of the hydrophilic binder include a hydrolyzate of a compound having a hydrolyzable group bonded to a silicon atom, and a hydrolysis condensate thereof; and a polymer having a hydrophilic group. Details of each component will be described later.

As the hydrophilic component, from the viewpoint that robustness is more excellent, at least one selected from the group consisting of a silicate-based compound, a monomer having a hydrophilic group (hereinafter, also referred to as a “hydrophilic monomer”), and a polymer having a hydrophilic group (hereinafter, also referred to as a “hydrophilic polymer”) is preferable, and a silicate-based compound is more preferable.

The monomer having a hydrophilic group is intended to be a compound having a hydrophilic group and a polymerizable group. In a case where the present composition contains a polymerization initiator described later, the hydrophilic monomer is polymerized to form a hydrophilic polymer.

Hereinafter, the silicate-based compound, the hydrophilic monomer, and the hydrophilic polymer will be described.

### Silicate-Based Compound

In the present specification, the silicate-based compound is a compound selected from the group consisting of a compound having a hydrolyzable group bonded to a silicon atom, a hydrolyzate thereof, and a hydrolysis condensate thereof, and examples thereof include at least one selected from the group consisting of a compound represented by Formula (1), a hydrolyzate thereof, and a hydrolysis condensate thereof.

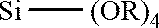

In Formula (1), R’s represent an alkyl group having 1 to 4 carbon atoms, and may be the same or different from each other. Specific examples thereof include MKC silicate MS51 of Mitsubishi Chemical Corporation, and Methyl silicate 51 and Methyl silicate 53 of Colcoat Co., Ltd.

The hydrolyzate of the compound represented by Formula (1) is intended to be a compound obtained by hydrolyzing the OR group in the compound represented by Formula (1). The above-described hydrolyzate may be a compound in which all of the OR groups are hydrolyzed (completely hydrolyzed product) or a compound in which some of the OR groups are hydrolyzed (partially hydrolyzed product). That is, the above-described hydrolyzate may be the completely hydrolyzed product, the partially hydrolyzed product, or a mixture thereof.

In addition, the hydrolysis condensate of the compound represented by Formula (1) is intended to be a compound obtained by hydrolyzing the OR group in the compound represented by Formula (1), and condensing the obtained hydrolyzate. The above-described hydrolysis condensate may be a compound in which all of the OR groups are hydrolyzed and all of the hydrolyzates are condensed (completely hydrolyzed and condensed product) or a compound in which some of the OR groups are hydrolyzed and some of the hydrolyzates are condensed (partially hydrolyzed and condensed product). That is, the above-described hydrolysis condensate may be the completely hydrolyzed and condensed product, the partially hydrolyzed and condensed product, or a mixture thereof.

A degree of condensation of the hydrolysis condensate is preferably 1 to 100, more preferably 1 to 20, and still more preferably 3 to 15.

The compound represented by Formula (1) is in a state in which at least a part of the compound is hydrolyzed by being mixed with a water component. The hydrolyzate of the compound represented by Formula (1) is obtained by reacting the compound represented by Formula (1) with the water component to change the OR group bonded to silicon to a hydroxy group. In the hydrolysis, not all of the OR groups need to react, but in order to exhibit hydrophilicity after coating, it is preferable that as many OR groups as possible are hydrolyzed. In addition, the minimum amount of the water component required for the hydrolysis is a molar amount equal to the OR groups of the compound represented by Formula (1), but in order for the reaction to proceed smoothly, a large excess amount of water is preferable.

The above-described hydrolysis reaction and condensation reaction of the silicate-based compound proceed at room temperature, but in order to promote the reactions, heating may be performed. In addition, a longer reaction time is preferable because the reactions proceed more. In addition, the hydrolyzate can be obtained in approximately half a day in the presence of a catalyst.

Examples of a suitable aspect of the above-described silicate-based compound include a compound represented by Formula (X).

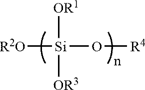

In Formula (X), R¹ to R⁴ each independently represent an alkyl group having 1 to 4 carbon atoms. In addition, n represents an integer of 2 to 100.

n is preferably 3 to 15, and more preferably 5 to 10.

Examples of a commercially available product of the above-described silicate-based compound include “Ethyl silicate 48” manufactured by Colcoat Co., Ltd. and “MKC silicate MS51” manufactured by Mitsubishi Chemical Corporation.

The silicate-based compound may be used singly, or two or more kinds thereof may be used in combination.

### Monomer Having Hydrophilicity (Hydrophilic Monomer)

The type of the hydrophilic group is not particularly limited, and examples thereof include a polyoxyalkylene group (for example, a polyoxyethylene group, a polyoxypropylene group, and a polyoxyalkylene group in which an oxyethylene group and an oxypropylene group are block-bonded or bonded randomly), an amino group, a carboxy group, an alkali metal salt of a carboxy group, a hydroxy group, an alkoxy group, an amide group, a carbamoyl group, a sulfonamide group, a sulfamoyl group, a sulfonic acid group, and an alkali metal salt of a sulfonic acid group. The number of hydrophilic groups in the hydrophilic monomer is not particularly limited, but is preferably 2 or more, more preferably 2 to 6, and still more preferably 2 or 3.

The type of the polymerizable group is not particularly limited, and examples thereof include a radically polymerizable group, a cationically polymerizable group, and an anionically polymerizable group. Examples of the radically polymerizable group include a (meth)acryloyl group, an acrylamide group, a vinyl group, a styryl group, and an allyl group. Examples of the cationically polymerizable group include a vinyl ether group, an oxiranyl group, and an oxetanyl group. As the polymerizable group, among these, a (meth)acryloyl group is preferable.

The number of polymerizable groups in the hydrophilic monomer is not particularly limited, but is preferably 2 or more, more preferably 2 to 6, and still more preferably 2 or 3.

A structure of a main chain of the hydrophilic polymer formed by polymerizing the hydrophilic monomer is not particularly limited, and examples thereof include polyurethane, poly(meth)acrylate, polystyrene, polyester, polyamide, polyimide, and polyurea.

The hydrophilic monomer may be used singly, or two or more kinds thereof may be used in combination.

### Polymer Having Hydrophilicity (Hydrophilic Polymer)

The type of the hydrophilic polymer is not particularly limited, and a known polymer can be used. The definition of the hydrophilic group is as described above.

Examples of the hydrophilic polymer include a polymer obtained by polymerizing the above-described hydrophilic monomer. In addition, examples thereof include a cellulose-based compound. The cellulose-based compound is intended to be a compound having cellulose as a mother nucleus, and examples thereof include carboxymethyl cellulose and a nanofiber made of triacetyl cellulose as a raw material.

A weight-average molecular weight of the hydrophilic polymer is not particularly limited, but from the viewpoint that handling property such as solubility is more excellent, the weight-average molecular weight is preferably 1,000 to 1,000,000 and more preferably 10,000 to 500,000. In the present specification, the weight-average molecular weight is defined as a value in terms of polystyrene, obtained by a gel permeation chromatography measurement.

The hydrophilic polymer may be used singly, or two or more kinds thereof may be used in combination.

A content of the hydrophilic component in the present composition is not particularly limited, but is preferably 0.10% to 0.50% by mass, more preferably 0.10% to 0.40% by mass, and still more preferably 0.20% to 0.31% by mass with respect to the total mass of the composition.

In addition, the content of the hydrophilic component in the present composition is not particularly limited, but is preferably 20% to 99.8% by mass, more preferably 20% to 90% by mass, and still more preferably 40% to 90% by mass with respect to the total solid content of the composition.

The solid content is intended to be components other than the solvent in the composition. In a case where the property of the above-described component is in a liquid state, it is counted as the solid content.

The hydrophilic component may be used singly, or two or more kinds thereof may be used in combination. In a case where two or more kinds of hydrophilic components are used in combination, it is preferable that the total content thereof is within the range described above.

### Antibacterial Agent

The type of the antibacterial agent is not particularly limited, and examples thereof include known antibacterial agents.

The antibacterial agent may be an inorganic substance or an organic substance. In other words, examples of the antibacterial agent include an inorganic antibacterial agent and an organic antibacterial agent. Among these, from the viewpoint that excellent antibacterial property can be maintained for a long period of time, an inorganic substance (inorganic antibacterial agent) is preferable.

Examples of the inorganic antibacterial agent include an antibacterial agent containing a metal.

Examples of the metal include silver, copper, zinc, mercury, iron, lead, bismuth, titanium, tin, and nickel. In addition, an aspect of the metal contained in the antibacterial agent is not particularly limited, and examples thereof include forms such as metal particles, a metal ion, a metal oxide, and a metal salt (including a metal complex).

Among these, as the metal, from the viewpoint that the antibacterial property of the present composition is more excellent, at least one selected from the group consisting of silver, copper, and zinc is preferable, and silver is more preferable.

As the antibacterial agent containing a metal, a metal-carrying carrier including a carrier and the above-described metal carried in the carrier is preferable.

The type of the carrier is not particularly limited, and examples thereof include known carriers. Examples of the carrier include inorganic oxides (for example, zeolite, silica gel, zirconium phosphate, calcium phosphate, and the like); activated carbon; metal carrier; organic metal; and a polymer particle. Among these, as the carrier, from the viewpoint that the antibacterial property of the present composition is more excellent, an inorganic oxide or a polymer particle is preferable, and glass or a polymer particle is more preferable.

More specific examples of the inorganic oxide as the carrier include zinc-calcium phosphate, calcium phosphate, zirconium phosphate, aluminum phosphate, aluminum silicate, calcium silicate, activated carbon, activated alumina, silica gel, zeolite, apatite, hydroxyapatite, titanium phosphate, potassium titanate, bismuth oxide hydrate, zirconium oxide hydrate, and hydrotalcite.

The carrier may be crystalline or non-crystalline (amorphous), but the carrier is preferably non-crystalline, and glass is more preferable. Examples of a material which can form the glass include silicate, borosilicate, and phosphate.

As the antibacterial agent containing a metal, from the viewpoint that the antibacterial property of the present composition is more excellent and that the present composition has not only an antibacterial effect against the Escherichia coli but also effects against molds and viruses, a silver-based antibacterial agent or a copper-based antibacterial agent is preferable.

In a case where the antibacterial agent contains the metal (particularly silver or copper), it is also preferred from the viewpoint that the antibacterial agent has not only an antibacterial effect against pathogenic bacteria but also antibacterial properties against fungi such as molds as well as antiviral properties against viruses. Examples of the virus related to the effect include an influenza virus, a SARS coronavirus (SARS-CoV), and a novel coronavirus (SARS-CoV-2). In addition, an effect against a novel coronavirus mutant (SARS-CoV-2 B.1.17, B.1.351, P.1, B.1.617.2, and the like) can be expected. As an evaluation method for the antiviral properties, a known method can be used. For example, by using a method described in ISO 21702, the antiviral properties can be measured by changing a test virus to a virus of interest, such as the influenza virus, the SARS coronavirus, and the novel coronavirus. It is sufficient that an antiviral activity value is larger than 1, but it is preferably 2.0 or more and more preferably more than 2.0.

The above-described silver-based antibacterial agent is intended to be an antibacterial agent containing silver. The form of silver is not particularly limited, and the silver is included, for example, in a form of metallic silver, a silver ion, or a silver salt (including a silver complex). In the present specification, the silver complex is included in the range of the silver salt.

Examples of the silver salt include silver acetate, silver acetylacetonate, silver azide, silver acetylide, silver arsenate, silver benzoate, silver hydrogen fluoride, silver bromate, silver bromide, silver carbonate, silver chloride, silver chlorate, silver chromate, silver citrate, silver cyanate, silver cyanide, silver (cis,cis-1,5-cyclooctadiene)-1,1,1,5,5,5-hexafluoroacetylacetonate, silver diethyldithiocarbamate, silver(I) fluoride, silver(II) fluoride, silver 7,7-dimethyl-1,1,1,2,2,3,3-heptafluoro-4,6-octanedionate, silver hexafluoroantimonate, silver hexafluoroarsenate, silver hexafluorophosphate, silver iodate, silver iodide, silver isothiocyanate, potassium silver cyanide, silver lactate, silver molybdate, silver nitrate, silver nitrite, silver(I) oxide, silver(II) oxide, silver oxalate, silver perchlorate, silver perfluorobutyrate, silver perfluoropropionate, silver permanganate, silver perrhenate, silver phosphate, silver picrate monohydrate, silver propionate, silver selenate, silver selenide, silver selenite, sulfadiazine silver, silver sulfate, silver sulfide, silver sulfite, silver telluride, silver tetrafluoroborate, silver tetraiodomercurate, silver tetratungstate, silver thiocyanate, silver p-toluenesulfonate, silver trifluoromethanesulfonate, silver trifluoroacetate, and silver vanadate.

In addition, examples of the silver complex include a histidine-silver complex, a methionine-silver complex, a cysteine-silver complex, an aspartic acid-silver complex, a pyrrolidone carboxylate-silver complex, an oxotetrahydrofuran carboxylate-silver complex, and an imidazole-silver complex.

As the silver-based antibacterial agent, a silver-carrying inorganic oxide is preferable. The silver-carrying inorganic oxide includes an inorganic oxide and silver carried in the inorganic oxide.

As the silver-carrying inorganic oxide, among these, silver-carrying zeolite, silver-carrying apatite, silver-carrying zirconium phosphate, silver-carrying glass phosphate, or silver-carrying calcium silicate is preferable.

Examples of the commercially available silver-based antibacterial agent include silver zeolite-based antibacterial agents such as “Zeomic” manufactured by Sinanen Zeomic Co., Ltd., “Silwell” manufactured by Fuji Silysia Chemical Ltd., and “Bactenon” manufactured by JAPAN ELECTRONIC MATERIALS CORPORATION; silver-based antibacterial agent obtained by carrying silver in an inorganic ion exchanger ceramic, such as “NOVARON” manufactured by Toagosei Co., Ltd. and “ATOMY BALL” manufactured by JGC Catalysts and Chemicals Ltd.; silver particles such as a “Nanosilver” manufactured by JAPAN ION Corporation; and silver-carrying ceramic particles (silver ceramic particles) in which silver is chemically bonded to a ceramic, such as “Bactekiller” and “Bactelite” manufactured by Fuji Chemical Industries, Ltd. In addition, as the copper-based antibacterial agent, an antibacterial agent including a copper ion (Cu⁺ or Cu²⁺) is preferable. Specific examples thereof include “IMADEZE” manufactured by Koken Co., Ltd.

Examples of the organic antibacterial agent include a quaternary ammonium salt, a phenol ether derivative, an imidazole derivative, a sulfone derivative, an N-haloalkylthio compound, an anilide derivative, a pyrrole derivative, a pyridine-based compound, a triazine-based compound, a benzoisothiazoline-based compound, and an isothiazoline-based compound.

The antibacterial agent is preferably in a form of particles. In particular, in a case where the antibacterial agent is an inorganic substance, the antibacterial agent is preferably in a form of particles.

In a case where the antibacterial agent is in a form of particles, an average particle diameter thereof is not particularly limited, but is preferably 0.01 µm or more and more preferably 0.3 µm or more. The upper limit thereof is preferably 3.0 µm or less, and more preferably 1.0 µm or less.

The average particle diameter of the antibacterial agent can be measured using an electron microscope. Specifically, the above-described average particle diameter is a value obtained by measuring diameters of primary particles and secondary particles (the term “secondary particles” is defined as aggregates formed by fusion or contact of the primary particles) of the particles of the antibacterial agent from an image of the electron microscope, and averaging a diameter of the particles in a range of 90%, excluding 5% of particles on the side of the smallest diameter and 5% of particles on the side of the largest diameter among the total number of the particles. That is, the average particle diameter is a value obtained from the primary particles and the secondary particles. In addition, the diameter refers to a circumscribe circle-equivalent diameter of the particles.

In addition, in a case where there is no significant difference in particle shape, a cumulative diameter (D50) at 50% by volume is measured three times using a laser diffraction scattering-type particle size distribution analyzer manufactured by HORIBA, Ltd., and an average value of the three measurements may be used as the average particle diameter.

The average particle diameter of the antibacterial agent can be adjusted by a known method in the related art, and examples thereof include methods such as dry pulverization and wet pulverization. In the dry pulverization, for example, a mortar, a jet mill, a hammer mill, a pin mill, a rotary mill, a vibration mill, a planetary mill, a beads mill, or the like is appropriately used. In addition, in the wet pulverization, for example, various ball mills, a high-speed rotary crusher, a jet mill, a beads mill, an ultrasound homogenizer, a high-pressure homogenizer, or the like is appropriately used.

For example, in the beads mill, the average particle diameter can be controlled by adjusting a diameter or a type of the beads as a medium, a mixing amount, or the like.

A content of the antibacterial agent in the present composition is not particularly limited, but is preferably 0.004% to 0.060% by mass, more preferably 0.005% to 0.030% by mass, and still more preferably 0.013% to 0.022% by mass with respect to the total mass of the composition.

In addition, the content of the antibacterial agent in the present composition is not particularly limited, but is preferably 0.001% to 50% by mass, more preferably 0.01% to 40% by mass, still more preferably 0.01% to 15% by mass, particularly preferably 0.01% to 10% by mass, and most preferably 0.03% to 5% by mass with respect to the total solid content of the composition.

The antibacterial agent may be used singly, or two or more kinds thereof may be used in combination. In a case where two or more kinds of antibacterial agents are used in combination, it is preferable that the total content thereof is within the range described above.

In a case where the antibacterial agent contains a metal, a content of the metal is not particularly limited, but is preferably 0.1% to 30% by mass and more preferably 0.5% to 5% by mass with respect to the total mass of the antibacterial agent.

### Solvent

The present composition contains a solvent.

The type of the solvent is not particularly limited, and examples thereof include water and/or an organic solvent.

The water is preferably purified water, and more preferably distilled water, ion exchange water, reverse osmosis (RO) water, pure water, or ultrapure water. Among these, from the viewpoint of stability of the antibacterial agent, ion exchange water is still more preferable.

An electrical conductivity of the water is preferably 0.1 to 0.2 mS/m.

Examples of the organic solvent include alcohol-based solvents such as methanol, ethanol, n-propanol, isopropanol, n-butanol, isobutanol, sec-butanol, tert-butanol, n-pentanol, isopentanol, phenylethyl alcohol, capryl alcohol, lauryl alcohol, and myristyl alcohol; glycol ether-based solvents such as methyl cellosolve, ethyl cellosolve, ethylene glycol dimethyl ether, ethylene glycol diethyl ether, propylene glycol monomethyl ether, propylene glycol monoethyl ether, propylene glycol monopropyl ether, propylene glycol dimethyl ether, propylene glycol diethyl ether, propylene glycol diethyl ether, ethylene glycol monobutyl ether, diethylene glycol monobutyl ether, triethylene glycol monobutyl ether, tetraethylene glycol monobutyl ether, and dipropylene glycol monobutyl ether; aromatic hydrocarbon-based solvents such as benzene, toluene, xylene, and ethylbenzene; alicyclic hydrocarbon-based solvents such as cyclopentane, cyclohexane, methylcyclohexane, and ethylcyclohexane; ether-based solvents such as tetrahydrofuran, dioxane, diisopropyl ether, and di-n-butyl ether; ketone-based solvents such as acetone, methyl ethyl ketone, and methyl isobutyl ketone; ester-based solvents such as methyl acetate, ethyl acetate, n-propyl acetate, isopropyl acetate, n-butyl acetate, isobutyl acetate, n-amyl acetate, isoamyl acetate, hexyl acetate, ethyl propionate, and butyl propionate; and hydrophilic solvents such as a 10% by mass denatonium benzoate alcohol solution, geraniol, octaacetylated sucrose, brucine, linalool, linalyl acetate, and acetic acid.

An amount of the solid content of the present composition is not particularly limited, but from the viewpoint that the composition has more excellent coating properties, it is preferably 0.001% to 80% by mass, more preferably 0.01% to 10% by mass, still more preferably 0.1% to 5.0% by mass, and particularly preferably 0.1% to 1.0% by mass with respect to the total mass of the composition. It is preferable to contain the solvent in the composition so as to obtain the above-described solid content.

The solvent may be used singly, or two or more kinds thereof may be used in combination.

From the viewpoint that the effect of the present invention is more excellent, the present composition preferably contains an alcohol-based solvent, and a content of the alcohol-based solvent is preferably 82.0% by mass or less with respect to the total mass of the composition. The lower limit thereof is not particularly limited, but is preferably 20% by mass or more and more preferably 55.0% by mass or more.

In a case of containing the alcohol-based solvent, from the viewpoint of aggregation stability of the antibacterial agent, it is preferable that the water is further contained as the solvent.

In a case where two or more kinds of alcohol-based solvents are contained in the present composition (for example, in a case where ethanol and isopropanol are used), it is preferable that the total amount thereof is within the range described above.

### Other Components

The present composition may contain components other than the above-described components.

In a case where the present composition contains the silicate-based compound, the present composition may contain a catalyst which promotes the condensation of the silicate-based compound.

The type of the catalyst is not particularly limited, and examples thereof include an alkali catalyst and an organic metal catalyst.

Examples of the alkali catalyst include sodium hydroxide, potassium hydroxide, and tetramethylammonium hydroxide.

Examples of the organic metal catalyst include aluminum chelate compounds such as aluminum bis(ethylacetoacetate) mono(acetylacetonate), aluminum tris(acetylacetonate), and aluminum ethylacetoacetate diisopropylate; zirconium chelate compounds such as zirconium tetrakis(acetylacetonate) and zirconium bis(butoxy)bis(acetylacetonate); titanium chelate compounds such as titanium tetrakis(acetylacetonate) and titanium bis(butoxy)bis(acetylacetonate); and organotin compounds such as dibutyltin diacetate, dibutyltin dilaurate, and dibutyltin dioctiate.

The type of the catalyst is not particularly limited, but an organic metal catalyst is preferable, and among these, an aluminum chelate compound or a zirconium chelate compound is more preferable, and an aluminum chelate compound is still more preferable.

A commercially available product can be used as the catalyst. Specific examples thereof include Aluminum Chelate A, Aluminum Chelate D, Aluminum Chelate M, ALCH, and ALCH-TR, which are trade names of Kawaken Fine Chemicals Co., Ltd.

A content of the catalyst in the present composition is not particularly limited, but from the viewpoint that the effect of the present invention is more excellent, it is preferably 0.005% to 0.0025% by mass and more preferably 0.011% to 0.019% by mass with respect to the total mass of the composition.

The catalyst may be used singly, or two or more kinds thereof may be used in combination. In a case where two or more kinds of catalysts are used in combination, it is preferable that the total content thereof is within the range described above.

### Dispersant

In a case where the present composition contains a granular antibacterial agent, it is preferable that the present composition contains a dispersant.

The type of the dispersant is not particularly limited, and examples thereof include known dispersants.

As the dispersant, a nonionic or anionic dispersant is preferable. From the viewpoint of affinity with the antibacterial agent, a dispersant (anionic dispersant) having an anionic polar group such as a carboxy group, a phosphoric acid group, and a hydroxyl group is more preferable.

A commercially available product can be used as the anionic dispersant. Specific examples thereof include DISPERBYK (registered trademark)-110, -111, -116, -140, -161, -162, -163, -164, -170, -171, -174, -180, and -182, which are trade names of BYK-Chemie.

A content of the dispersant in the present composition is not particularly limited, but is preferably 40% by mass or less, more preferably 20% by mass or less, and still more preferably 10% by mass or less with respect to the total solid content of the composition.

The dispersant may be used singly, or two or more kinds thereof may be used in combination. In a case where two or more kinds of dispersants are used in combination, it is preferable that the total content thereof is within the range described above.

### Surfactant

The above-described composition may contain a surfactant. The surfactant has an action of improving the coating properties of the present composition.

The surfactant is not particularly limited, and examples thereof include a nonionic surfactant and an ionic surfactant (for example, an anionic surfactant, a cationic surfactant, and an amphoteric surfactant).

Examples of the nonionic surfactant include polyethylene glycol monolauryl ether, polyethylene glycol monostearyl ether, polyethylene glycol monocetyl ether, polyethylene glycol monolauryl ester, and polyethylene glycol monostearyl ester.

Examples of the nonionic surfactant include EMALEX 715 manufactured by Nihon Emulsion Co., Ltd.

Examples of the ionic surfactant include anionic surfactants such as an alkyl sulfate, an alkylbenzene sulfonate, and an alkyl phosphate; cationic surfactants such as an alkyltrimethylammonium salt and a dialkyldimethylammonium salt; and amphoteric surfactants such as an alkyl carboxybetaine.

Examples of the anionic surfactant include sodium di(2-ethylhexyl)sulfosuccinate.

A content of the surfactant in the present composition is not particularly limited, but is preferably 0.01 parts by mass or more with respect to 100 parts by mass of the total solid content of the composition. The upper limit value of the content of the surfactant is not particularly limited, but is preferably 10 parts by mass or less and more preferably 7 parts by mass or less with respect to 100 parts by mass of the total solid content of the composition.

The surfactant may be used singly, or two or more kinds thereof may be used in combination. In a case where two or more kinds thereof are used in combination, it is preferable that the total content thereof is within the range described above. In a case where two or more kinds of surfactants are used, from the viewpoint of the aggregation stability of the antibacterial agent, a combination of the nonionic surfactant and the anionic surfactant is preferable.

Examples of the other components in addition to the above-described catalyst include a polymerization initiator, a film-forming agent, and a fragrance.

According to the purpose, the present composition can be diluted with water and/or alcohol before use. In addition, a fragrance may be added to the present composition before use. The type of the fragrance is not limited, but it is preferable to select a compound which does not impair the antibacterial property.

The fragrance may be added to the present composition, and the present composition may be further diluted before use.

### Manufacturing Method of Composition

The present composition can be prepared by appropriately mixing the above-described essential components and optional components. The order of mixing the above-described components is not particularly limited.

### Antibacterial Liquid Material

The present composition can be used as an antibacterial liquid material. That is, the present invention also relates to an antibacterial liquid material containing the present composition.

### Agent Form

An agent form of the composition according to the embodiment of the present invention is not particularly limited, and examples thereof include a liquid agent, a gel agent, an aerosol spray agent, and a non-aerosol spray agent, and a gel agent is preferable.

### Wet Wiper

The wet wiper according to the embodiment of the present invention has a foundation cloth and the present composition impregnated into the foundation cloth.

The present composition is as described above.

The type of the foundation cloth is not particularly limited, and may be a foundation cloth formed of a natural fiber or a chemical fiber.

Examples of the natural fiber include pulp, cotton, hemp, flax, wool, camel, cashmere, mohair, and silk.

Examples of a material of the chemical fiber include rayon, polynosic, acetate, triacetate, nylon, polyester, polyacrylonitrile, polyvinyl alcohol, polyvinyl chloride, polyvinylidene chloride, polyethylene, polypropylene, polyurethane, polyalkylene paraoxybenzoate, and polychlal.

Examples of the foundation cloth of the above-described wet wiper include a nonwoven fabric, a cloth, a towel, a gauze, and degreased cotton, and a nonwoven fabric is preferable.

In addition, an areal weight (mass per unit area) of the foundation cloth is preferably 100 g/m² or less. An impregnation amount in a case where the foundation cloth is impregnated with the present composition is preferably 1 times or more the mass of the foundation cloth.

### Spray

The spray according to the embodiment of the present invention has a spray container and the present composition stored in the spray container.

The present composition is as described above.

As an example of the spray according to the embodiment of the present invention, a form in which the present composition and a propellant are filled in a predetermined container can be mentioned. The propellant used is not particularly limited, and examples thereof include hydrofluoroolefin, dimethyl ether (DME), and liquefied petroleum gas (LPG). In addition to the above-described propellant (or instead of the above-described propellant), a compressed gas such as carbon dioxide gas, nitrogen gas, compressed air, and oxygen gas may be used.

In particular, in a case of the aerosol spray agent, a blending proportion (volume ratio) of the present composition to the propellant is preferably 1/99 to 35/65, more preferably 5/95 to 30/70, and still more preferably 5/95 to 25/75. By setting such a volume ratio, an injection speed can be easily adjusted to be 10 to 35 seconds/50 mL. As a result, the present composition easily reaches the ceiling, the wall, or the like in a case where the present composition is used in an application space such as a bathroom.

### Manufacturing Method of Surface-Treated Base Material

By bringing the present composition into contact with a base material, a surface-treated base material having antibacterial property, antiviral property, deodorant property, antifungal property, and the like can be manufactured. That is, the present invention includes a manufacturing method of a surface-treated base material, in which the present composition is brought into contact with the base material to manufacture the surface-treated base material.

A method of bringing the present composition into contact with the base material is not particularly limited, and examples thereof include a spray method, a roll coater method, a gravure coater method, a screen method, a spin coater method, a flow coater method, an ink jet method, an electrostatic coating method, and a wipe method. Among these, from the viewpoint that it is possible to form a film on a surface of an existing article and treat the film according to demand (on-demand treatment), a spray method or a wipe method is preferable.

As the wipe method, a method of wiping the base material with the above-described wet wiper to bring the present composition into contact with the base material is preferable.

In addition, as the spray method, a method of spraying the present composition to the base material using the above-described spray to bring the present composition into contact with the base material is preferable.

After the present composition is brought into contact with the base material, a heat treatment may be performed to remove the solvent. The conditions for the heat treatment in this case are not particularly limited, and for example, the heating temperature is preferably 50° C. to 200° C. and the heating time is preferably 15 to 600 seconds.

The base material is not particularly limited, and examples thereof include clothes including underwear, bedding, nursing care products such as diapers, toilets, floors, and walls.

A material which constitutes the base material is not particularly limited, and examples thereof include a metal, glass, a ceramic, and a plastic (resin). Among these, in a case where the present composition is applied to a metal base material, the occurrence of rust on the metal base material can be suppressed.

In a case where the present composition contains the hydrophilic binder precursor, after bringing the present composition into contact with the base material, the obtained base material may be subjected to a curing treatment as necessary. By performing the curing treatment, the hydrophilic binder precursor becomes a hydrophilic binder. As a result, a film including the antibacterial agent and the hydrophilic binder is obtained on the base material.

A method of the curing treatment is not particularly limited, and examples thereof include a heat treatment and/or an exposure treatment.

The exposure treatment is not particularly limited, and examples thereof include an aspect of irradiating the base material with ultraviolet rays at an irradiation amount of 100 to 600 mJ/cm² using an ultraviolet lamp.

In a case of the ultraviolet irradiation, ultraviolet rays emitted from light rays of an ultrahigh pressure mercury lamp, a high pressure mercury lamp, a low pressure mercury lamp, a carbon arc, a xenon arc, a metal halide lamp, or the like can be utilized.

The temperature for the heat treatment is not particularly limited, but is preferably 50° C. to 150° C. and more preferably 80° C. to 120° C.

A film thickness of the obtained film is not particularly limited, but is preferably 0.001 to 50 µm and more preferably 0.01 to 10 µm.

The above-described film thickness is intended to be a value obtained by embedding a sample piece of the film in a resin, cutting cross sections with a microtome, and observing the cut cross-sections with a scanning electron microscope, measuring thicknesses at random ten positions of the film, and calculating an arithmetic average thereof.

### Mask with Antibacterial Agent

The mask with an antibacterial agent according to the embodiment of the present invention has a mask and an antibacterial portion which is disposed on the mask and includes an antibacterial agent formed from the present composition.

The present composition is as described above.

The antibacterial portion includes the antibacterial agent and also includes the hydrophilic binder (for example, the hydrophilic polymer).

The antibacterial portion may be in a form of a film. In addition, the antibacterial portion may be disposed on the entire surface of the mask, or may be disposed on a part thereof.

The type of the mask is not particularly limited, and a known mask can be used.

A method of forming the antibacterial portion including the antibacterial agent formed from the present composition on the mask is not particularly limited, and examples thereof include a method of using the mask as the base material in the above-described manufacturing method of a surface-treated base material.

### Face Guard with Antibacterial Agent

The face guard with an antibacterial agent according to the embodiment of the present invention has a face guard and an antibacterial portion which is disposed on the face guard and includes an antibacterial agent formed from the present composition.

The present composition is as described above.

The antibacterial portion includes the antibacterial agent and also includes the hydrophilic binder (for example, the hydrophilic polymer).

The antibacterial portion may be in a form of a film. In addition, the antibacterial portion may be disposed on the entire surface of the face guard, or may be disposed on a part thereof.

The type of the face guard is not particularly limited, and a known face guard can be used.

A method of forming the antibacterial portion including the antibacterial agent formed from the present composition on the face guard is not particularly limited, and examples thereof include a method of using the face guard as the base material in the above-described manufacturing method of a surface-treated base material.

### Air Filter with Antibacterial Agent

An air filter with an antibacterial agent can be produced using the composition according to the embodiment of the present invention.

The air filter with an antibacterial agent has an air filter and an antibacterial portion which is disposed on the air filter and includes an antibacterial agent formed from the present composition.

The present composition is as described above.

The antibacterial portion includes the antibacterial agent and also includes the hydrophilic binder (for example, the hydrophilic polymer).

The antibacterial portion may be in a form of a film. In addition, the antibacterial portion may be disposed on the entire surface of the air filter, or may be disposed on a part thereof.

The type of the air filter is not particularly limited, and a known air filter can be used. Suitable examples of the air filter include a high efficiency particulate air filter (HEPA) filter and an ultra low penetration air filter (ULPA) filter.

A method of forming the antibacterial portion including the antibacterial agent formed from the present composition on the air filter is not particularly limited, and examples thereof include a method of using the air filter as the base material in the above-described manufacturing method of a surface-treated base material. As the forming method, the present composition may be applied onto the air filter to form the antibacterial portion or the present composition may be kneaded into air filter fibers to form the antibacterial portion, but it is preferable to form the antibacterial portion by coating.

By forming the antibacterial portion formed from the present composition on the air filter, in addition to suppressing growth of bacteria and viruses, it is possible to suppress generation and growth of mold on the filter, and odor caused by these can be suppressed.

In addition, by forming the antibacterial portion on the surface of the air filter fiber, a rate of catching dust is improved. It is considered that the reason why the above-described effects are obtained is that electrostatic property of the surface of the filter fiber changes, so that a dust removal rate increases due to the static electricity effect. In addition, it is considered that the dust removal rate increases by making the surface of the filter fiber hydrophilic.

### Development of Other Applications of Surface Treatment of Present Invention

The antibacterial portion formed from the present composition can be preferably applied not only to the air filter but also to a filtration filter, a metal mesh, a filter cloth, and the like.

The air filter subjected to the above-described treatments can be applied to an indoor air conditioner, an air conditioner, an air purifier, an automobile air conditioner, a drain hole of a bathroom and a washbasin, and the like.

In addition, from the viewpoint of imparting antibacterial property, antiviral property, deodorant property, and antifungal property, it is also preferable to treat a surface of an air conditioning duct, a drain pipe, a liquid feeding pipe, and the like with the present composition.

### EXAMPLES

Hereinafter, the present invention will be described in more detail based on Examples. The materials, the amounts of materials used, the proportions, the treatment details, and the treatment procedure shown in Examples below may be appropriately modified as long as the modifications do not depart from the spirit of the present invention. Therefore, the scope of the present invention should not be construed to be limited by Examples described below.

### Example 1

In a container, while stirring ethanol (760 g), a siloxane compound (“MKC (registered trademark) silicate MS-51” manufactured by Mitsubishi Chemical Corporation; corresponding to the compound represented by Formula (X), n = 2 to 100) (2.9 g), Aluminum Chelate D (manufactured by Kawaken Fine Chemicals Co., Ltd.; aluminum bis(ethylacetoacetate) mono(acetylacetonate); diluted with ethanol; concentration of solid contents: 76% by mass) (0.23 g), isopropyl alcohol (IPA) (38.5 g), a nonionic surfactant (“EMALEX 715” manufactured by Nihon Emulsion Co., Ltd.; diluted with ion exchange water; concentration of solid contents: 0.5% by mass) (47.3 g), an anionic surfactant (sodium di(2-ethylhexyl)sulfosuccinate; diluted with ion exchange water; concentration of solid contents: 1.0% by mass) (2.36 g), and ion exchange water (128 g) were sequentially added to the ethanol, 21.01 g of an antibacterial agent particle solution previously prepared was added thereto, and the mixture was stirred for 30 minutes to obtain a composition 1.

The antibacterial agent particle solution was prepared by a method in which, while stirring ethanol (19.6 g) in a container, a dispersant (DISPERBYK-180) (0.61 g) was added to the ethanol, the mixture was stirred for 15 minutes, a silver-carrying glass dispersion liquid (“BACTERITE MP-103DV” manufactured by Fuji Chemical Industries Co., Ltd.; inorganic carrier of “BACTERITE MP-103DV” manufactured by Fuji Chemical Industries Co., Ltd. corresponds to a phosphate glass dispersion liquid; concentration of solid contents: 25% by mass; content of silver is 2% by mass with respect to the total mass of the silver-carrying glass) (0.80 g) was added thereto, and the mixture was stirred for 15 minutes.

### Example 2

A composition 2 was obtained according to the same procedure as in Example 1, except that the amount of the ion exchange water was changed from 122 g to 476 g.

### Examples 3 to 11

Compositions 3 to 11 were obtained according to the same procedure as in Example 1, except that the amounts of components used were adjusted as shown in Table 1.

### Comparative Example 1

A composition C1 was obtained according to the same procedure as in Example 1, except that the amount of the siloxane compound used was changed 2.9 g to 5.8 g.

### Comparative Examples 2 to 4

Compositions C2 to C4 were obtained according to the same procedure as in Example 1, except that the amounts of components used were adjusted as shown in Table 1.

### Evaluation of Antibacterial Property

Using the compositions 1 to 11 and compositions C1 to C4 obtained above, a first antibacterial activity value and a second antibacterial activity value were calculated according to the following test 1 and test 2, respectively. The results are shown in Table 1.

Test 1: an Escherichia coli solution (0.4 mL) was dropped onto a PET film (length 5 cm × width 5 cm) in a Petri dish, and the Petri dish was covered with a PET film (length 4 cm × width 4 cm). The Petri dish was allowed to stand for 3 hours under the conditions of 35 ± 1° C. and a relative humidity of 90% RH or more for culturing. After 3 hours, the film and the PET film were placed in a stomacher bag, and an SCDLP culture medium (10 mL) was added thereto to wash out the Escherichia coli. The number of viable bacteria in the washed-out solution was measured by an agar plate culture method, and a common logarithmic value of the number of viable bacteria is defined as a common logarithmic value X1.

Next, a nonwoven fabric impregnated with each composition and another PET film (length 5 cm × width 5 cm) were prepared, 9.6 g/m² of the composition was applied onto the PET film by wiping the PET film with the nonwoven fabric, and a drying operation at room temperature for 10 minutes was repeated five times to obtain a PET film coated with the composition. The PET film (length 5 cm × width 5 cm) coated with the composition was placed in a Petri dish, an Escherichia coli solution (0.4 mL) was dropped onto the PET film, and the Petri dish was covered with a PET film (length 4 cm × width 4 cm). The Petri dish was allowed to stand for 3 hours under the conditions of 35 ± 1° C. and a relative humidity of 90% RH or more for culturing. After 3 hours, the film and the PET film were placed in a stomacher bag, and an SCDLP culture medium (10 mL) was added thereto to wash out the Escherichia coli. The number of viable bacteria in the washed-out solution was measured by an agar plate culture method, and a common logarithmic value of the number of viable bacteria is defined as a common logarithmic value Y1.

The above-described nonwoven fabric impregnated with the composition was produced by immersing a nonwoven fabric (rayon:PET:polyethylene (PE) = 5:3:2, areal weight amount: 4 g/m²) in 10 mL of each composition for 24 hours.

Next, a difference between the common logarithmic value X1 and the common logarithmic value Y1 obtained above was calculated as the first antibacterial activity value.

Test 2: an Escherichia coli solution (0.4 mL) was dropped onto a PET film (length 5 cm × width 5 cm) in a Petri dish, and the Petri dish was covered with a PET film (length 4 cm × width 4 cm). The Petri dish was allowed to stand for 24 hours under the conditions of 35 ± 1° C. and a relative humidity of 90% RH or more for culturing. After 24 hours, the film and the PET film were placed in a stomacher bag, and an SCDLP culture medium (10 mL) was added thereto to wash out the Escherichia coli. The number of viable bacteria in the washed-out solution was measured by an agar plate culture method, and a common logarithmic value of the number of viable bacteria is defined as a common logarithmic value X2.

Next, a nonwoven fabric impregnated with each composition and another PET film (length 5 cm × width 5 cm) were prepared, 9.6 g/m² of the composition was applied onto the PET film by wiping the PET film with the nonwoven fabric, and a drying operation at room temperature for 10 minutes was repeated five times to obtain a PET film coated with the composition. The PET film (length 5 cm × width 5 cm) coated with the composition was placed in a Petri dish, an Escherichia coli solution (0.4 mL) was dropped onto the PET film, and the Petri dish was covered with a PET film (length 4 cm × width 4 cm). The Petri dish was allowed to stand for 24 hours under the conditions of 35 ± 1° C. and a relative humidity of 90% RH or more for culturing. After 24 hours, the film and the PET film were placed in a stomacher bag, and an SCDLP culture medium (10 mL) was added thereto to wash out the Escherichia coli. The number of viable bacteria in the washed-out solution was measured by an agar plate culture method, and a common logarithmic value of the number of viable bacteria is defined as a common logarithmic value Y2.

Next, a difference between the common logarithmic value X2 and the common logarithmic value Y2 obtained above was calculated as the second antibacterial activity value.

### Evaluation of Rust Preventive Property

As a standard test, a nonwoven fabric impregnated with each composition was prepared, a SUS tray was wiped with the nonwoven fabric, and 9.6 g/m² of the composition was applied onto the SUS tray once a day. After continuously performing the above-described operation for 6 months, the presence or absence of rust on the SUS tray was checked.

In addition, as a compulsory test, a nonwoven fabric impregnated with the composition was prepared, a SUS tray was wiped with the nonwoven fabric, and 9.6 g/m² of the composition was applied onto the SUS tray ten times a day. After continuously performing the above-described operation for 1 month under an environment of a temperature of 25° C. and a humidity of 80%, the presence or absence of rust on the SUS tray was checked.

In each of the standard test and the compulsory test, a case where no rust occurred was designated as “A”, and a case where the rust occurred was designated as “B”.

A case of “A” in both the standard test and the compulsory test was judged as “AA”, a case of “A” only in the standard test and “B” in the compulsory test was judged as “A”, and a case of “B” in both the standard test and the compulsory test was judged as “B”.

In the case of A in the standard test, there is no problem in practical use. In other words, in a case where the judgement was “A” or higher, there is no problem in practical use.

The columns of “Raw material” and “Antibacterial agent particle solution” in the column of “Composition” described in Table 1 indicate the amount (g) of raw materials used to prepare the composition.

The column of “Binder” indicates the amount (g) of the siloxane compound used.

The column of “Catalyst solution (g)” indicates the amount (g) of Aluminum Chelate D used.

The column of “Nonion (g)” indicates the amount (g) of EMALEX 715 used.

The column of “Anion (g)” indicates the amount of the aqueous dilution (concentration of solid contents: 1.0% by mass) of sodium di(2-ethylhexyl)sulfosuccinate used.

The column of “Dispersant (g)” indicates the amount (g) of DISPERBYK-180 used.

The column of “Antibacterial dispersion liquid (g)” indicates the amount (g) of BACTERITE MP-103DV used.

The column of “Hydrophilic component concentration (% by mass)” indicates the content of the siloxane compound described in the column of “Binder” with respect to the total mass of the composition.

The column of “Catalyst concentration (% by mass)” indicates the content of aluminum bis(ethylacetoacetate) mono(acetylacetonate) with respect to the total mass of the composition.

The column of “Antibacterial agent concentration 1 (% by mass)” indicates the content of silver-carrying glass with respect to the total mass of the composition.

The column of “Antibacterial agent concentration 2 (% by mass)” indicates the content of silver-carrying glass with respect to the total solid content of the composition.

The column of “Alcohol concentration (% by mass)” indicates the total content of ethanol and isopropanol with respect to the total mass of the composition.

The column of “Test 1” indicates of the first antibacterial activity value calculated by the test 1, and the column of “Test 2” indicates of the second antibacterial activity value calculated by the test 2.

The column of “Rust preventive property (standard)” indicates the result of <Evaluation of rust preventive property> (Standard test) described above, and the column of “Rust preventive property (compulsory)” indicates the result of <Evaluation of rust preventive property> (Compulsory test) described above.

| | Composition | | | | | | | | | | | | | | | Evaluation | | | | |
|---|---|---|---|---|---|---|---|---|---|---|---|---|---|---|---|---|---|---|---|---|
| | Raw Material | | | | | | | Antibacterial agent particle solution | | | Compositional ratio | | | | | | | | | |
| | Ethanol (g) | Binder(g) | Catalyst solution(g) | IPA(g) | Nonion(g) | Anion(g) | Iomn rechargewater (g) | Ethanol (g) | Dispersant (g) | Antibacterial dispersive liquid (g) | Hydrophilic component concentration (% by mass) | Catalyst concentration (% by mass) | Antibacterial agent concentration 1 (% by mass) | Antibacterial agent concentration 2 (% by mass) | Alcohol concentration (% by mass) | Test 1 | Test | Rust preventive property (standard) | Rust preventive property (compulsory) | Judgement |
| Example 1 | 760 | 2.9 | 0.23 | 38.5 | 47.3 | 2.36 | 128 | 19.6 | 0.61 | 0.8 | 0.29 | 0.017 | 0.020 | 4.8 | 81.8 | 3.7 | 5.6 | A | A | AA |
| Example 2 | 760 | 2.9 | 0.23 | 38.5 | 47.3 | 2.36 | 128 | 19.6 | 0.61 | 0.8 | 0.22 | 0.013 | 0.013 | 4.8 | 59.2 | 2.6 | 4.1 | A | A | AA |
| Example 3 | 760 | 3.9 | 0.23 | 38.5 | 47.3 | 2.36 | 128 | 19.6 | 0.61 | 0.8 | 0.29 | 0.017 | 0.020 | 3.9 | 81.7 | 3.6 | 5.4 | A | A | AA |
| Example 4 | 760 | 4.3 | 0.23 | 38.5 | 47.3 | 2.6 | 128 | 19.6 | 0.61 | 0.8 | 0.45 | 0.017 | 0.020 | 3.3 | 81.7 | 4.0 | 3.6 | A | B | A |
| Example 5 | 760 | 2.1 | 0.23 | 38.5 | 47.3 | 2.36 | 128 | 19.6 | 0.61 | 0.8 | 0.21 | 0.017 | 0.020 | 6.0 | 81.4 | 3.2 | 4.4 | A | A | AA |
| Example 6 | 760 | 1.0 | 0.23 | 38.5 | 47.3 | 2.36 | 128 | 19.6 | 0.61 | 0.8 | 0.10 | 0.018 | 0.020 | 3.9 | 81.9 | 2.8 | 4.2 | A | A | AA |
| Example 7 | 760 | 2.9 | 0.32 | 38.5 | 87.3 | 2.36 | 128 | 19.6 | 0.61 | 0.8 | 0.29 | 0.024 | 0.020 | 4.8 | 81.8 | 3.3 | 4.9 | A | A | AA |
| Example 8 | 760 | 2.9 | 0.29 | 38.5 | 47.3 | 2.36 | 128 | 19.6 | 0.61 | 0.8 | 0.29 | 0.007 | 0.020 | 5.0 | 81.8 | 2.4 | 4.1 | A | A | AA |
| Example 9 | 760 | 2.9 | 0.23 | 38.5 | 47.3 | 2.36 | 128 | 19.6 | 1.83 | 2.4 | 0.29 | 0.017 | 0.060 | 4.4 | 81.8 | 3.9 | 5.7 | A | B | A |
| Example 10 | 760 | 2.9 | 0.23 | 38.5 | 47.3 | 2.36 | 128 | 19.6 | 6.38 | 0.5 | 0.29 | 0.017 | 0.013 | 3.3 | 81.8 | 3.3 | 4.6 | A | A | AA |
| Example 11 | 253 | 1.0 | 0.08 | 12.8 | 15.8 | 0.50 | 700 | 6.6 | 0.29 | 0.8 | 0.10 | 0.006 | 0.020 | 12.9 | 27.2 | 2.0 | 4.0 | A | A | AA |
| Comparative Example 1 | 760 | 5.8 | 0.23 | 38.5 | 47.3 | 2.36 | 128 | 19.6 | 0.61 | 0.8 | 0.53 | 0.017 | 0.020 | 2.9 | 81.5 | 4.3 | 5.7 | B | B | B |
| Comparative Example 2 | 760 | 2.9 | 0.37 | 38.5 | 47.3 | 2.36 | 128 | 19.6 | 0.61 | 0.8 | 0.29 | 0.028 | 0.020 | 4.7 | 81.5 | 4.2 | 3.2 | B | B | B |
| Comparative Example 3 | 760 | 298 | 0.23 | 38.5 | 47.3 | 2.38 | 128 | 19.6 | 4.00 | 6.0 | 0.29 | 0.017 | 0.14 | 12.9 | 81.8 | 1.2 | 5.0 | B | B | B |

As shown in Table 1, it was confirmed that the present composition exhibited a desired effect.

From Examples 4 and 9, it was confirmed that the effect was more excellent in a case where the first antibacterial activity value of the test 1 was 3.8 or less.

### Example 12

A composition 12 was obtained according to the same procedure as in Example 1, except that BACTERITE MP-103DV was changed to a zirconium phosphate-based silver-based antibacterial agent (manufactured by Fuji Chemical Industries Co., Ltd.; average particle diameter: 1.0 µm; silver content: 3.7% by mass) in the same amount.

### Example 13

A composition 13 was obtained according to the same procedure as in Example 1, except that BACTERITE MP-103DV was changed to IMADEZE (manufactured by Koken Co., Ltd.) in the same amount.

### Example 14

A composition 14 was obtained according to the same procedure as in Example 1, except that Aluminum Chelate D was changed to Aluminum Chelate A in the same amount.

### Example 15

A composition 15 was obtained according to the same procedure as in Example 1, except that “MKC (registered trademark) silicate MS-51” manufactured by Mitsubishi Chemical Corporation was changed to “Ethyl silicate 48” manufactured by Colcoat Co., Ltd. in the same amount.

### Example 16

A composition 16 was obtained according to the same procedure as in Example 1, except that “MKC (registered trademark) silicate MS-51” manufactured by Mitsubishi Chemical Corporation was changed to “Ethyl silicate 48” manufactured by Colcoat Co., Ltd. in a half amount.

In a case where the above-described evaluations were carried out using the obtained compositions 12 to 16, the judgement was “AA” in any of the compositions.

What is claimed is:

1. A composition comprising:
a hydrophilic component selected from the group consisting of a hydrophilic binder precursor and a hydrophilic binder;
an antibacterial agent; and
a solvent,
wherein a first antibacterial activity value obtained by the following test 1 is 4.0 or less, and
a second antibacterial activity value obtained by the following test 2 is 4.0 or more,
Test 1: in a case where Escherichia coli is inoculated on a polyethylene terephthalate film and a common logarithmic value of the number of viable bacteria on the polyethylene terephthalate film after culturing the Escherichia coli for 3 hours under conditions of 35 ± 1° C. and a relative humidity of 90% RH or more is defined as a common logarithmic value X1, and in a case where 9.6 g/m² of the composition is applied onto a polyethylene terephthalate film using a nonwoven fabric impregnated with the composition and a drying operation is repeated five times to produce a polyethylene terephthalate film coated with the composition, Escherichia coli is inoculated on the polyethylene terephthalate film coated with the composition, and a common logarithmic value of the number of viable bacteria on the polyethylene terephthalate film coated with the composition after culturing the Escherichia coli for 3 hours under conditions of 35 ± 1° C. and a relative humidity of 90% RH or more is defined as a common logarithmic value Y1, a difference between the common logarithmic value X1 and the common logarithmic value Y1 is calculated as the first antibacterial activity value,
Test 2: in a case where Escherichia coli is inoculated on a polyethylene terephthalate film and a common logarithmic value of the number of viable bacteria on the polyethylene terephthalate film after culturing the Escherichia coli for 24 hours under conditions of 35 ± 1° C. and a relative humidity of 90% RH or more is defined as a common logarithmic value X2, and in a case where 9.6 g/m² of the composition is applied onto a polyethylene terephthalate film using a nonwoven fabric impregnated with the composition and a drying operation is repeated five times to produce a polyethylene terephthalate film coated with the composition, Escherichia coli is inoculated on the polyethylene terephthalate film coated with the composition, and a common logarithmic value of the number of viable bacteria on the polyethylene terephthalate film coated with the composition after culturing the Escherichia coli for 24 hours under conditions of 35 ± 1° C. and a relative humidity of 90% RH or more is defined as a common logarithmic value Y2, a difference between the common logarithmic value X2 and the common logarithmic value Y2 is calculated as the second antibacterial activity value.

2. The composition according to claim 1,
wherein a content of the hydrophilic component is 0.20% to 0.31% by mass with respect to a total mass of the composition.

3. The composition according to claim 1,
wherein a content of the antibacterial agent is 0.005% to 0.060% by mass with respect to a total mass of the composition.

4. The composition according to claim 1,
wherein a content of the antibacterial agent is 0.013% to 0.022% by mass with respect to a total mass of the composition.

5. The composition according to claim 1,
wherein the antibacterial agent contains silver.

6. The composition according to claim 1,
wherein the hydrophilic component is a silicate-based compound.

7. The composition according to claim 6, further comprising:
a catalyst which promotes a condensation of the silicate-based compound.

8. The composition according to claim 7,
wherein a content of the catalyst is 0.011% to 0.019% by mass with respect to a total mass of the composition.

9. The composition according to claim 1,
wherein the solvent contains an alcohol-based solvent, and
a content of the alcohol-based solvent is 82.0% by mass or less with respect to a total mass of the composition.

10. The composition according to claim 1,
wherein the composition is a gel agent.

11. A wet wiper comprising:
a foundation cloth; and
the composition according to claim 1, which is impregnated into the foundation cloth.

12. A spray comprising:
a spray container; and
the composition according to claim 1, which is stored in the spray container.

13. A mask with an antibacterial agent, comprising:
a mask; and
an antibacterial portion which is disposed on the mask and includes an antibacterial agent formed from the composition according to claim 1.

14. A face guard with an antibacterial agent, comprising:
a face guard; and
an antibacterial portion which is disposed on the face guard and includes an antibacterial agent formed from the composition according to claim 1.

15. An antibacterial liquid material comprising:
the composition according to claim 1.

16. The composition according to claim 2,
wherein a content of the antibacterial agent is 0.005% to 0.060% by mass with respect to a total mass of the composition.

17. The composition according to claim 2,
wherein a content of the antibacterial agent is 0.013% to 0.022% by mass with respect to a total mass of the composition.

18. The composition according to claim 2,
wherein the antibacterial agent contains silver.

19. The composition according to claim 2,
wherein the hydrophilic component is a silicate-based compound.

20. The composition according to claim 19, further comprising:
a catalyst which promotes a condensation of the silicate-based compound.
